(19) United States
(12) Patent Application Publication
(10) Pub. No.: US 2010/0033479 A1
(43) Pub. Date: Feb. 11, 2010

(54) APPARATUS, METHOD, AND COMPUTER PROGRAM PRODUCT FOR DISPLAYING STEREOSCOPIC IMAGES

(76) Inventors: Yuzo Hirayama, Kanagawa (JP); Rieko Fukushima, Tokyo (JP); Akira Morishita, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/161,258

(22) PCT Filed: Feb. 29, 2008
(86) PCT No.: PCT/JP2008/054105

§ 371 Date: Jul. 17, 2008

(30) Foreign Application Priority Data
Mar. 7, 2007 (JP) 2007-057551

(51) Int. Cl. G06F 3/033; G06T 15/00; H04N 15/00

(52) U.S. Cl. 345/419; 345/158; 348/51; 348/E15.001

(57) ABSTRACT

A stereoscopic image display apparatus includes a detecting unit that detects a position and an orientation direction of a handheld device that is positioned on or near three-dimensional display screen; a calculation processing unit that performs a calculation process for displaying a three-dimensional image in a position that is successive or close to the handheld device, based on the position and the orientation direction of the handheld device; and a display controlling unit that causes the three-dimensional image to be displayed as a conjunctive three-dimensional image in the position that is successive or close to the handheld device, based on a result of the calculation process performed by the calculation processing unit.

### TECHNICAL FIELD

The present invention relates to a stereoscopic image display apparatus, a method, and a computer program product for generating a stereoscopic image that is movable in conjunction with a real object.

### BACKGROUND ART

Various methods are known that can be used by stereoscopic-view image display apparatuses that are operable to display moving pictures (i.e., so-called three-dimensional display devices). In recent years, there has been an increasing demand for flat-panel type display apparatuses that do not require special eye-glasses or the like. A method that can be relatively easily realized is to place a light beam controlling element in front of a display panel in which the positions of the pixels are fixed, such as a direct-view-type liquid crystal display device, a projection-type liquid crystal display device, or a plasma display device, the light beam controlling element being configured so as to control light beams from the display panel so that the light beams are directed toward the viewer.

Such a light beam controlling element is generally known as a parallax barrier and controls the light beams so that, in a given position on the light beam controlling element, mutually different images are viewed depending on the angle. More specifically, when only a left-right parallax (i.e., a horizontal parallax) is to be applied, slits or a lenticular sheet (i.e., a cylindrical lens array) is used as the light beam controlling element. When an up-down parallax (i.e., a vertical parallax) is also to be applied, a pin-hole array or a lens array is used as the light beam controlling element.

Methods in which a parallax barrier is used can be further classified into a two-view method, a multi-view method, a super multi-view method (i.e., a multi-view method with a super multi-view condition), and an integral imaging method (hereinafter, “II method”). The basic principle used in these methods is substantially the same as the one that was invented about 100 years ago and has been used in stereoscopic photography.

Because a distance of sight is generally finite, a display image is generated so that a perspective projection image can be actually viewed at the distance of sight, regardless of whether the II method is used or the multi-view method is used. In the II method in which only a horizontal parallax is used and no vertical parallax is used, in a case where the pitch of the parallax barrier in the horizontal direction is an integer multiple of the pitch of the pixels in the horizontal direction, there is a set of parallel light beams. Thus, an image in which the vertical direction corresponds to a perspective projection for a certain distance of sight and the horizontal direction corresponds to a parallel projection is divided in units of rows of pixels. Then, the divided image is combined into a parallax combined image that is in an image format displayable on a display screen. As a result, a stereoscopic image that is properly projected is obtained (see, for example, Patent Documents 1 and 2). In particular, the II method is suitable for interactive purposes such as to perform an operation to directly point to the reproduced image (i.e., the three-dimensional image), because the light beams from a real object are reproduced.

With three-dimensional display devices that use such a light beam reproduction method for displaying a stereoscopic image by reproducing light beams, it is possible to reproduce a stereoscopic image having high quality by increasing the data of the reproduced light beams, for example, by increasing the number of viewpoints in the case where the multi-view method is used, and by increasing the number of light beams that are in mutually different directions on the base of the display screen, in the case where the II method is used.

### Patent Document 1:

### JP-A 2004-295013 (KOKAI)

### Patent Document 2:

### JP-A 2005-86414 (KOKAI)

When the II method is used, however, although the user is able to directly point to a three-dimensional image (i.e., an optical real image) that is reproduced to the front of a display panel (i.e., on the optical real-image side), the user is not able to directly point to a three-dimensional image (i.e., an optical virtual image) that is reproduced behind the display panel (i.e., on the optical virtual-image side), because the display panel is physically in the way between the three-dimensional image and the user.

In view of the problem described above, it is an object of the present invention to provide a stereoscopic image display apparatus, a stereoscopic image displaying method, and a stereoscopic image displaying computer program with which it is possible to improve operability for three-dimensional images in the stereoscopic image display apparatus that uses the integral imaging method or the light beam reproduction method.

### DISCLOSURE OF INVENTION

To solve the problem described above and achieve the object, the present invention provides a stereoscopic image display apparatus that displays a three-dimensional image by using an integral imaging method or a light beam reproduction method, and includes a position detecting unit that detects a position and an orientation direction of a handheld device positioned inside or near a display space provided over a three-dimensional display screen; a calculation processing unit that performs a calculation process for displaying the three-dimensional image in a position that is successive or close to the handheld device, based on the position and the orientation direction of the handheld device; and a display controlling unit that causes the three-dimensional image to be displayed as a conjunctive three-dimensional image in the position that is successive or close to the handheld device, based on a result of the calculation process performed by the calculation processing unit.

Further, the present invention provides a stereoscopic image displaying method used by a stereoscopic image display apparatus that displays a three-dimensional image by using an integral imaging method or a light beam reproduction method. The stereoscopic image display method includes detecting a position and an orientation direction of a handheld device that is positioned inside or near a display space provided over a three-dimensional display screen; performing a calculation process for displaying the three-dimensional image in a position that is successive or close to the handheld device, based on the position and the orientation direction of the handheld device; and causing the three-dimensional image to be displayed as a conjunctive three-dimensional image in the position that is successive or close to the handheld device, based on a result of the calculation process performed at the calculation processing step.

Furthermore, the present invention provides a computer program product having a computer readable medium including programmed instructions for displaying a three-dimensional image by using an integral imaging method or a light beam reproduction method, wherein the instructions, when executed by a computer, cause the computer to perform: detecting a position and an orientation direction of a handheld device positioned inside or near a display space provided over a three-dimensional display screen and held by a user; performing a calculation process for displaying the three-dimensional image in a position that is successive or close to the handheld device, based on the position and the orientation direction of the handheld device; and causing the three-dimensional image to be displayed as a conjunctive three-dimensional image in the position that is successive or close to the handheld device, based on a result of the calculation process performed by the step of calculation processing.

### BRIEF DESCRIPTION OF DRAWINGS

FIG. 1 is a diagram illustrating a hardware configuration of a stereoscopic image display apparatus.

FIG. 2 is a diagram illustrating an example of a functional configuration of the stereoscopic image display apparatus.

FIG. 3 is a drawing illustrating a stereoscopic image displaying unit.

FIG. 4 is a drawing for explaining an II method.

FIG. 5 is a drawing for explaining a method for detecting the position and the orientation direction of a handheld device.

FIG. 6 is a drawing for explaining a principle of detecting the position and the orientation direction of the handheld device.

FIG. 7 is another drawing for explaining the principle of detecting the position and the orientation direction of the handheld device.

FIG. 8 is a drawing for explaining a relationship between the stereoscopic image displaying unit and the handheld device.

FIG. 9 is a flowchart of an example of a stereoscopic image displaying process.

FIG. 10 is a drawing illustrating an example of a functional configuration of another stereoscopic image display apparatus.

FIG. 11 is a flowchart of another example of a stereoscopic image displaying process.

FIG. 12 is a drawing illustrating an example of a functional configuration of yet another stereoscopic image display apparatus.

FIG. 13 is a flowchart of yet another example of a stereoscopic image displaying process.

FIG. 14 is a drawing illustrating an example of a functional configuration of yet another stereoscopic image display apparatus.

FIG. 15 is a flowchart of yet another example of a stereoscopic image displaying process.

FIG. 16 is a drawing illustrating an example of a functional configuration of yet another stereoscopic image display apparatus.

FIG. 17 is a drawing for explaining a method for detecting a rotation angle of the handheld device.

FIG. 18 is a drawing for explaining a principle of detecting a rotation angle of the handheld device.

FIG. 19 is another drawing for explaining the principle of detecting a rotation angle of the handheld device.

FIG. 20 is a drawing illustrating point-like light emitting members provided in the handheld device.

FIG. 21 is a drawing for explaining a method for detecting a rotation angle of the handheld device.

FIG. 22 is a drawing for explaining a principle of detecting the rotation angle of the handheld device.

FIG. 23 is a flowchart of yet another example of a stereoscopic image displaying process.

### BEST MODE(S) FOR CARRYING OUT THE INVENTION

Exemplary embodiments of a stereoscopic image display apparatus, a stereoscopic image displaying method, and a stereoscopic image displaying computer program will be explained, with reference to the accompanying drawings.

### First Embodiment

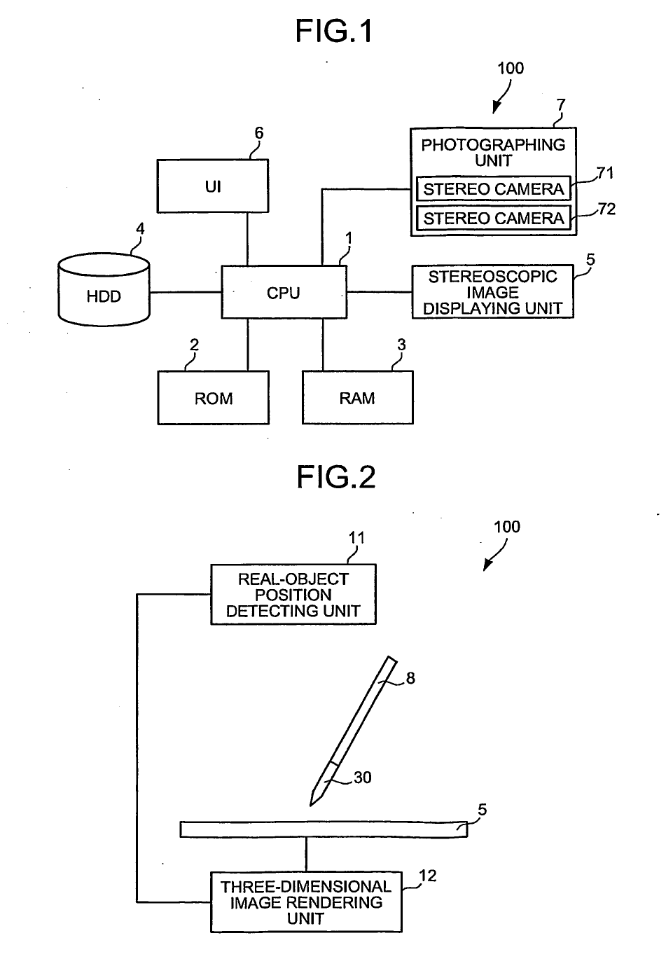

FIG. 1 is a block diagram illustrating a hardware configuration of a stereoscopic image display apparatus 100 according to a first embodiment of the present invention. The stereoscopic image display apparatus 100 is configured so as to include a Central Processing Unit (CPU) 1 that performs information processing; a Read-Only Memory (ROM) 2 that stores therein a Basic Input/Output System (BIOS) and the like; a Random Access Memory (RAM) 3 that stores therein various types of data in a rewritable manner; a Hard Disk Drive (HDD) 4 that functions as an image storing unit storing therein, in advance, various types of contents related to displaying of stereoscopic images and also stores therein a computer program (i.e., a stereoscopic image displaying program) related to displaying of stereoscopic images (i.e., three-dimensional images); a stereoscopic image displaying unit 5 that uses an integral imaging method or a light beam reproduction method and outputs/displays a three-dimensional image; a User Interface (UI) 6 that is used by a user to input various types of instructions to the stereoscopic image display apparatus 100 and also displays various types of information; and a photographing unit 7 that includes stereo cameras 71 and 72. Stereoscopic image display apparatuses 101 to 104 that are explained later each have the same hardware configuration as the stereoscopic image display apparatus 100.

The CPU 1 controls the constituent elements by performing various types of computational processes according to the stereoscopic image displaying program. Characteristic processes according to the first embodiment that are performed by the CPU 1 based on the stereoscopic image displaying program will be explained below.

FIG. 2 is a block diagram illustrating a functional configuration of the stereoscopic image display apparatus 100 according to the first embodiment. As shown in FIG. 2, as a result of the CPU 1 controlling the constituent elements according to the stereoscopic image displaying program, the stereoscopic image display apparatus 100 includes a real-object position detecting unit 11 and a three-dimensional image rendering unit 12.

Next, the stereoscopic image displaying unit 5 will be explained. As shown in FIG. 2, the stereoscopic image displaying unit 5 is of a horizontal placement type that is designed to be placed on a desk or the like. The stereoscopic image displaying unit 5 is placed so that the actual horizontal plane, which is the horizontal plane in the real space, is parallel to the display screen. However, it is acceptable to place the stereoscopic image displaying unit 5 so as to be slightly at an angle with respect to the actual horizontal plane so that the display screen faces the viewer. The stereoscopic image displaying unit 5 displays a three-dimensional image that includes two-dimensional information, on a virtual plane in a three-dimensional space. In this situation, the two-dimensional information denotes information that is two-dimensionally expressed and includes, for example, characters and icons. More specifically, when a map image is displayed as a three-dimensional image, two-dimensional information such as place names and icons identifying buildings are displayed while being superimposed on the map image.

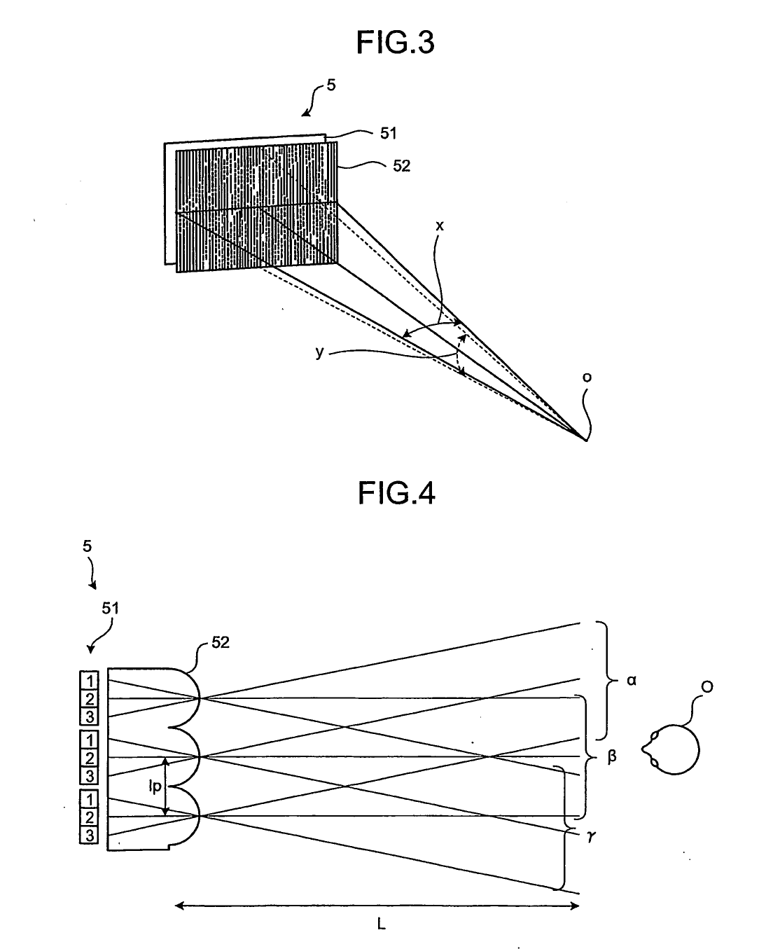

FIG. 3 is a drawing illustrating a general configuration of the stereoscopic image displaying unit 5. As shown in FIG. 3, the stereoscopic image displaying unit 5 includes an image displaying element 51 that is configured with, for example, a liquid crystal panel and a light beam controlling element 52 that is provided on the image displaying element 51.

The image displaying element 51 may be selected out of various types of display devices such as a direct-view-type liquid crystal display device, a projection-type liquid crystal display device, a plasma display device, a field emission display device, and an organic Electro Luminescence (EL) display device, as long as the pixels of which the positions are fixed are two-dimensionally arranged in a matrix structure in the display screen.

As the light beam controlling element 52, a lenticular lens array that extends in a substantially vertical direction and has a cyclic structure in a substantially horizontal direction is used. In this situation, there is a parallax only in the horizontal direction x, and the image changes depending on the distance of sight. However, because there is no parallax in the vertical direction y, the same image is viewed regardless of the viewing position. In FIG. 3, the reference character “O” denotes the position of a single eye of a viewer. In the first embodiment, the lenticular lens array in which a plurality of lenses are arranged in a row is used as the light beam controlling element 52. However, the present invention is not limited to this example. It is acceptable to use a parallax barrier in which a plurality of openings are arranged in a row, as the light beam controlling element 52.

In the display screen of the image displaying element 51 included in the stereoscopic image displaying unit 5 according to the first embodiment, subpixels corresponding to the colors of red (R), green (G), and blue (B) are arranged in an array formation. The subpixels corresponding to the colors of R, G, and B are realized by placing color filters on the display screen in an appropriate manner.

Shown in FIG. 4 is a principle of the display that uses the Integral Imaging (II) method. Mutually different images such as a first parallax image γ, a second parallax image β, and a third parallax image α can be viewed, depending on the position of the viewer or the viewing angle of the viewer. Thus, the viewer perceives three dimensions due to a parallax between a sight of the right eye and a sight of the left eye. In the case where the lenticular lens is used as the light beam controlling element 52, an advantage is that the display is brighter than in the case where slits are used, because the utilization efficiency of light is higher. In FIG. 4, the reference character “L” denotes a distance of sight, whereas the reference character “lp” denotes a lens pitch. In the explanation below, the space in which a viewer is able to perceive three dimensions over the display screen (i.e., the surface of the light beam controlling element 52) of the stereoscopic image displaying unit 5 will be referred to as a “display space”.

The image that is output to the stereoscopic image displaying unit 5 cannot be perceived as a normal image when being viewed without the light beam controlling element 52, because the parallax images are interleaved. Thus, the image is not suitable for applying an image compression thereto, such as Joint Photographic Experts Group (JPEG) or Moving Picture Experts Group (MPEG). Thus, the image storing unit (i.e., the HDD 4) stores therein an image in which the parallax images are arranged in an array formation and that has been compressed in advance. When the three-dimensional image is reproduced (displayed), the three-dimensional image rendering unit 12 decodes the image read from the HDD 4 so as to reconstruct the image and also performs an interleaving conversion process so as to convert the image into an image in a format that can be output to the stereoscopic image displaying unit 5. The three-dimensional image rendering unit 12 is also able to change the size of the image by enlarging or reducing it, before performing the interleaving conversion process on the decoded image. The reason is that, even if the size of the image is changed, the three-dimensional image rendering unit 12 is able to perform the interleaving conversion process properly.

Returning to the description of FIG. 2, the real-object position detecting unit 11 detects the position of a handheld device 8 that is positioned inside or near the display space of the stereoscopic image displaying unit 5 included in the stereoscopic image display apparatus 100 as well as the orientation direction (i.e., inclination) of the handheld device 8 with respect to the display screen of the stereoscopic image displaying unit 5. The handheld device 8 is an actually existing object that can be held in a user's hand and operated over the stereoscopic image displaying unit 5. For example, a stick-like object as shown in FIG. 2 may be used as the handheld device 8.

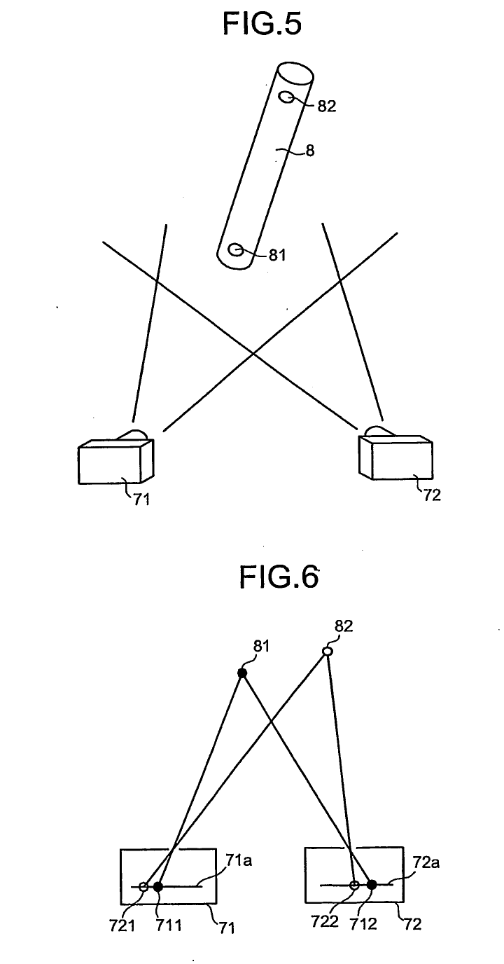

The method for detecting the position and the orientation direction of the handheld device 8 may be selected out of various types of methods. According to the first embodiment, the position and the orientation direction of the handheld device 8 is detected by using a method described below. Next, the method for detecting the position and the orientation direction of the handheld device 8 will be explained, with reference to FIGS. 5 to 7.

FIG. 5 is a drawing for explaining the method for detecting the position and the orientation direction of the handheld device 8. In this example, point-like light emitting members 81 and 82 are provided near both ends of the handheld device 8, respectively. The light beams emitted from the point-like light emitting members 81 and 82 are photographed by using the stereo cameras 71 and 72 included in the photographing unit 7. A photographed image is output to the real-object position detecting unit 11 as photograph information. The stereo cameras 71 and 72 are placed in predetermined positions. The areas that are photographed by the stereo cameras 71 and 72 include the area (i.e., the display space) in which an optical real image is displayable by the stereoscopic image displaying unit 5 included in the stereoscopic image display apparatus 100.

As the point-like light emitting members 81 and 82 provided in the handheld device 8, for example, infrared light emitting diodes may be used. Each of the point-like light emitting members 81 and 82 does not necessarily have to be a point light source in a strict sense. It is acceptable even if the light source has a certain dimension. In addition, an arrangement is preferable in which the color of the emitted light beam, the size of the light beam point, and the light emission conditions such as the time interval between light emissions is different between the point-like light emitting member 81 and the point-like light emitting member 82, so that it is possible to identify from which one of the point-like light emitting members 81 and 82, each light beam has been emitted.

FIG. 6 is a drawing for explaining a principle of detecting the position and the orientation direction of the handheld device 8. The light beam emitted from the point-like light emitting member 81 that is provided on one end of the handheld device 8 is photographed as a photographed picture 711 by an image pickup device 71a included in the stereo camera 71 and is also photographed as a photographed picture 712 by an image pickup device 72a included in the stereo camera 72. Similarly, the light beam emitted from the point-like light emitting member 82 that is provided on the other end of the handheld device 8 is photographed as a photographed picture 721 by the image pickup device 71a included in the stereo camera 71 and is also photographed as a photographed picture 722 by the image pickup device 72a included in the stereo camera 72.

The real-object position detecting unit 11 derives the position and the orientation direction of the handheld device 8, based on the photographed pictures of the emitted light beams that are included in the photographed images photographed by the stereo camera 71 and the stereo camera 72. More specifically, the real-object position detecting unit 11 detects the positions of the point-like light emitting members 81 and 82 based on the positions of the light beam points that have been recorded as the photographed pictures and a predetermined positional relationship between the stereo camera 71 and the stereo camera 72, by using the principle of triangulation.

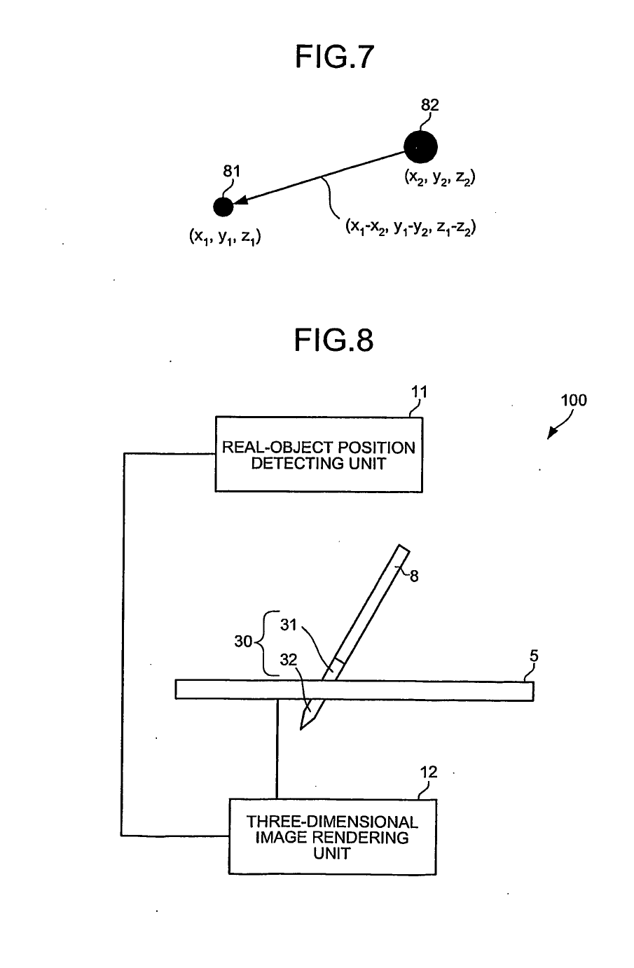

When the coordinates of the positions of the point-like light emitting members 81 and 82 are obtained, it is possible to easily calculate a vector from the point-like light emitting member 81 to the point-like light emitting member 82. In other words, as shown in FIG. 7, in a case where the coordinates of the position of the point-like light emitting member 81 is (X1, Y1, Z1) and the coordinates of the position of the point-like light emitting member 82 is (X2, Y2, Z2), the vector from the point-like light emitting member 82 to the point-like light emitting member 81 is derived as (X1-X2, Y1-Y2, Z1-Z2). The real-object position detecting unit 11 considers that the derived vector connecting the point-like light emitting member 81 and the point-like light emitting member 82 together is the orientation direction (i.e., the inclination) of the handheld device 8 with respect to the stereoscopic image displaying unit 5. With this arrangement, it is possible to detect the position and the orientation direction of the handheld device 8 in a simple and accurate manner.

In the first embodiment, the method for detecting the position and the orientation direction that has been explained with reference to FIGS. 5 to 7 is used. However, the present invention is not limited to this example. It is acceptable to use any other technique that is publicly known. For example, it is acceptable to detect the position and the orientation direction of the handheld device 8 by using a magnetic sensor, ultrasonic waves, a gyro sensor, or the like.

Returning to the description of FIG. 2, the three-dimensional image rendering unit 12 performs a calculation process for rendering a three-dimensional image, based on the position and the orientation direction of the handheld device 8 that have been calculated by the real-object position detecting unit 11. The three-dimensional image rendering unit 12 renders the three-dimensional image on the stereoscopic image displaying unit 5 so that a three-dimensional image 30 is displayed in a position that is successive or close to the handheld device 8. Before rendering the three-dimensional image, the three-dimensional image rendering unit 12 reads contents of the three-dimensional image to be displayed, from the HDD 4 serving as the image storing unit.

More specifically, the three-dimensional image rendering unit 12 renders the three-dimensional image 30 that is positioned at a point (e.g., (X1, Y1, Z1)) having the positional coordinates that have been detected by the real-object position detecting unit 11 and also has a direction vector oriented in the same direction (e.g., (X1-X2, Y1-Y2, Z1-Z2)) as the direction vector that has been calculated by the real-object position detecting unit 11. The three-dimensional image 30 that has been rendered in this manner is displayed in the position that is successive or close to the handheld device 8. In the following explanation, the three-dimensional image 30 that is displayed in a position that is successive or close to the handheld device 8 will be referred to as a conjunctive three-dimensional image 30.

Shown in FIG. 2 is an example in which the conjunctive three-dimensional image 30 is displayed in a position that is successive to an end of the handheld device 8. In the example shown in FIG. 2, the three-dimensional image rendering unit 12 uses the position of one of the point-like light emitting members 81 and 82 as a reference position and causes the conjunctive three-dimensional image 30 that is shaped like a pen tip to be displayed, starting from the reference position, in the direction of the inclination of the handheld device 8. The shape of the conjunctive three-dimensional image 30 is not limited to the example shown in FIG. 2. It is acceptable to arrange the conjunctive three-dimensional image 30 so as to have any other various shapes, depending on the usage environment.

Also, in the example shown in FIG. 2, the conjunctive three-dimensional image 30 is displayed in a position that is successive or close to one end of the handheld device 8, while the position of one of the point-like light emitting members 81 and 82 is used as a reference position. However, the present invention is not limited to this example. For example, another arrangement is acceptable in which the conjunctive three-dimensional image 30 is displayed in a position that is successive or close to both ends of the handheld device 8, while the positions of both of the point-like light emitting members 81 and 82 are used as reference positions. Further, yet another arrangement is acceptable in which the conjunctive three-dimensional image 30 is displayed in a position that is successive or close to the handheld device 8, while a position between the point-like light emitting members 81 and 82 is used as a reference position.

With this arrangement where the conjunctive three-dimensional image 30 is displayed in a position that is successive or close to the handheld device 8, it is possible to display the conjunctive three-dimensional image 30 and the handheld device 8 integrally. As a result, it is possible to provide, for the user, the handheld device 8 that is virtually extended by the size of the displayed conjunctive three-dimensional image 30. Thus, the user is able to move the conjunctive three-dimensional image 30 that is integrally displayed with the handheld device 8, by moving the handheld device 8. Thus, the user is able to intuitively operate the conjunctive three-dimensional image 30.

When performing the calculation process, the three-dimensional image rendering unit 12 checks the display position of the conjunctive three-dimensional image 30 on the stereoscopic image displaying unit 5. In a case where a part or all of the conjunctive three-dimensional image 30 is to be displayed behind the display screen of the stereoscopic image displaying unit 5 (i.e., displayed on the virtual image side), the three-dimensional image rendering unit 12 causes the part or all of the conjunctive three-dimensional image 30 corresponding to the portion that extends through the display screen to be displayed as an optical virtual image.

In other words, the three-dimensional image rendering unit 12 causes the conjunctive three-dimensional image 30 positioned behind the display screen of the stereoscopic image displaying unit 5 (i.e., on the virtual image side) to be displayed as an optical virtual image and causes the conjunctive three-dimensional image 30 positioned to the front of the display screen of the stereoscopic image displaying unit 5 (i.e., on the real image side) to be displayed as an optical real image. With this arrangement, the user is able to directly point to even the virtual image side of the stereoscopic image displaying unit 5 by using the conjunctive three-dimensional image 30 and operating the handheld device 8.

For example, as shown in FIG. 8, in a case where, as a result of an operation by the user, the handheld device 8 is positioned close to the stereoscopic image displaying unit 5 so that the conjunctive three-dimensional image 30 reaches the display screen of the stereoscopic image displaying unit 5, the three-dimensional image rendering unit 12 causes one portion of the conjunctive three-dimensional image 30 corresponding to the portion that extends through the display screen to be displayed as an optical virtual image 32. In contrast, the three-dimensional image rendering unit 12 causes the other portion of the conjunctive three-dimensional image 30 positioned over the display screen of the stereoscopic image displaying unit 5 to be displayed as an optical real image 31.

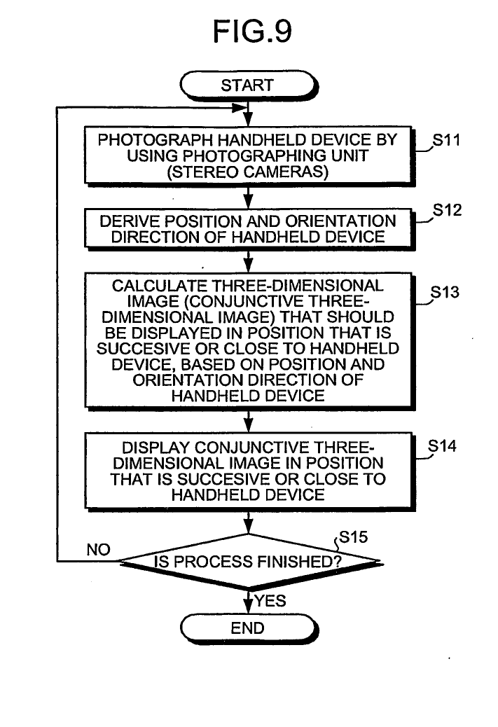

Next, an operation of the stereoscopic image display apparatus 100 according to the first embodiment will be explained, with reference to FIG. 9. FIG. 9 is a flowchart of a procedure in a stereoscopic image displaying process performed by the stereoscopic image display apparatus 100.

First, the stereo cameras 71 and 72 photograph light beams emitted from the point-like light emitting members 81 and 82 that are provided in the handheld device 8 (step S11). The real-object position detecting unit 11 then derives the position and the orientation direction of the handheld device 8 with respect to the stereoscopic image displaying unit 5, based on the photograph information obtained by the stereo cameras 71 and 72 (step S12).

Next, the three-dimensional image rendering unit 12 performs a calculation process for rendering a three-dimensional image in a position that is successive or close to the handheld device 8, based on the position and the orientation direction of the handheld device 8 that have been derived at step S12 (step S13) and causes the three-dimensional image to be displayed as the conjunctive three-dimensional image 30 in a position that is successive or close to the handheld device 8 (step S14).

At the following step, namely step S15, the real-object position detecting unit 11 judges whether this process should be finished. In a case where, for example, the photograph information that is input from the stereo cameras 71 and 72 includes photographed pictures of the emitted light beams (step S15: No), the process returns to step S11.

On the other hand, at step S15, in a case where the photograph information that is input from the stereo cameras 71 and 72 includes no photographed pictures of the emitted light beams because, for example, the handheld device 8 is positioned on the outside of the photographing areas of the stereo cameras 71 and 72 (step S15: Yes), the process is finished.

As explained above, because the conjunctive three-dimensional image 30 is displayed in a position that is successive or close to the handheld device 8, it is possible to display the conjunctive three-dimensional image 30 integrally with the handheld device 8. Thus, it is possible to virtually extend the handheld device 8 by the size of the displayed conjunctive three-dimensional image 30. With this arrangement, the user is able to directly point to another object image 40 displayed by the stereoscopic image displaying unit 5 by using the conjunctive three-dimensional image 30 that is integrally displayed with the handheld device 8 and operating the handheld device 8. Thus, it is possible to improve operability for the three-dimensional images.

### Second Embodiment

Next, a stereoscopic image display apparatus according to a second embodiment of the present invention will be explained. Some of the constituent elements that are the same as those explained in the first embodiment will be referred to by using the same reference characters, and the explanation thereof will be omitted.

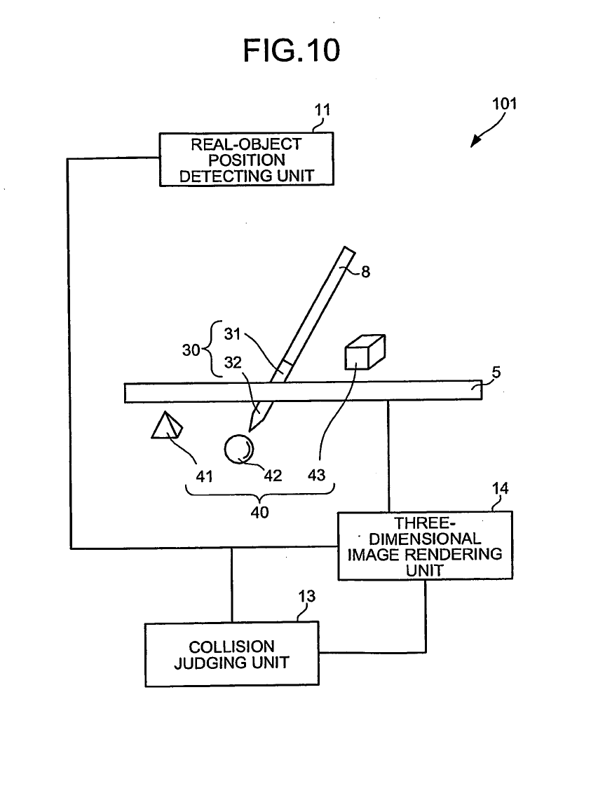

FIG. 10 is a drawing illustrating a functional configuration of the stereoscopic image display apparatus 101 according to the second embodiment. As shown in FIG. 10, as a result of the CPU 1 controlling the constituent elements according to the stereoscopic image displaying program, the stereoscopic image display apparatus 101 according to the second embodiment includes a collision judging unit 13 and a three-dimensional image rendering unit 14, in addition to the real-object position detecting unit 11 explained in the first embodiment.

Based on the position of another three-dimensional image (hereinafter, an “object image”) 40 other than the conjunctive three-dimensional image 30 that is displayed by the three-dimensional image rendering unit 14 and the position of the conjunctive three-dimensional image 30 that is displayed together with the handheld device 8 by the three-dimensional image rendering unit 14, the collision judging unit 13 judges whether the two three-dimensional images collide with each other. Also, when having judged that the two three-dimensional images collide with each other, the collision judging unit 13 outputs collision position information related to the collision position of the two three-dimensional images to the three-dimensional image rendering unit 14. Let us assume that it is possible to obtain the positions of the conjunctive three-dimensional image 30 and the object image 40, based on, for example, a result of a calculation process performed by the three-dimensional image rendering unit 14.

The three-dimensional image rendering unit 14 has functions that are similar to those of the three-dimensional image rendering unit 12 explained above. The three-dimensional image rendering unit 14 causes the conjunctive three-dimensional image 30 to be displayed in a position that is successive or close to the handheld device 8 and also causes the object image 40 to be displayed on one or both of the real image side and the virtual image side of the stereoscopic image displaying unit 5.

In addition, the three-dimensional image rendering unit 14 exercises control so as to change rendering of the object image 40 corresponding to the collision position that is indicated in the collision position information, based on the collision position information that has been input from the collision judging unit 13.

Let us discuss an example in which, as shown in FIG. 10, a triangular pyramid 41, a sphere 42, and a cube 43 are each displayed as the object image 40, and the conjunctive three-dimensional image 30 has collided with (has come in contact with) the sphere 42. In such a situation, the three-dimensional image rendering unit 14 changes the rendering of the sphere 42, based on the collision position information of the sphere 42 that has been input from the collision judging unit 13. For example, the three-dimensional image rendering unit 14 causes a representational effect to be displayed so as to express that the sphere 42 has a dent in the collided portion or the sphere 42 has a hole in the collided portion. In the second embodiment, the example is explained in which the rendering of the object image 40 that has collided with the conjunctive three-dimensional image 30 is changed. However, another arrangement is acceptable in which the rendering of the conjunctive three-dimensional image 30 is changed or the rendering of both of the images is changed.

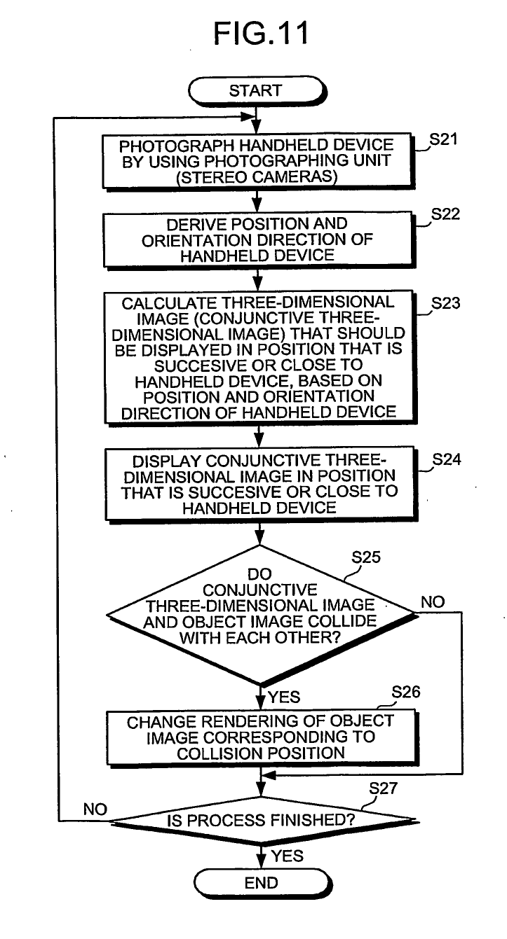

Next, an operation of the stereoscopic image display apparatus 101 according to the second embodiment will be explained, with reference to FIG. 11. FIG. 11 is a flowchart of a procedure in a stereoscopic image displaying process performed by the stereoscopic image display apparatus 101. It will be assumed herein that the object image 40 is displayed, in advance, in a predetermined position of the stereoscopic image displaying unit 5 by the three-dimensional image rendering unit 14.

First, the real-object position detecting unit 11 controls the stereo cameras 71 and 72 so that the stereo cameras 71 and 72 photograph light beams emitted from the point-like light emitting members 81 and 82 that are provided in the handheld device 8 (step S21). The real-object position detecting unit 11 then derives the position and the orientation direction of the handheld device 8 with respect to the stereoscopic image displaying unit 5, based on the photograph information obtained by the stereo cameras 71 and 72 (step S22).

Next, the three-dimensional image rendering unit 14 performs a calculation process for rendering a three-dimensional image in a position that is successive or close to the handheld device 8, based on the position and the orientation direction of the handheld device 8 that have been derived at step S22 (step S23) and causes the three-dimensional image to be displayed as the conjunctive three-dimensional image 30 in a position that is successive or close to the handheld device 8 (step S24).

Subsequently, based on the display positions of the conjunctive three-dimensional image 30 and the object image 40 that are displayed by the three-dimensional image rendering unit 14, the collision judging unit 13 judges whether these two images collide with each other (step S25). In a case where the collision judging unit 13 has judged that the conjunctive three-dimensional image 30 and the object image 40 do not collide with each other (step S25: No), the process immediately proceeds to the procedure at step S27.

On the other hand, at step S25, in a case where the collision judging unit 13 has judged that the conjunctive three-dimensional image 30 and the object image 40 collide with each other (step S25: Yes), the three-dimensional image rendering unit 14 changes the rendering of the object image 40 corresponding to the collision position, based on the collision position information that has been obtained by the collision judging unit 13 (step S26), and the process proceeds to the procedure at step S27.

At the following step, namely step S27, the real-object position detecting unit 11 judges whether this process should be finished. In a case where, for example, the position information of the handheld device 8 is continually input from the stereo cameras 71 and 72 (step S27: No), the process returns to step S21.

On the other hand, at step S27, in a case where the position information of the handheld device 8 is no longer input because, for example, the handheld device 8 is positioned on the outside of the photographing areas of the stereo cameras 71 and 72 (step S27: Yes), the process is finished.

As explained above, according to the second embodiment, it is possible to directly point to the other three-dimensional image that is displayed by the stereoscopic image displaying unit 5, by using the conjunctive three-dimensional image 30 displayed in a position that is successive or close to the handheld device 8. Thus, it is possible to improve operability for the three-dimensional images.

In addition, because it is possible to change the display of the object image 40 according to the collision of (the contact between) the conjunctive three-dimensional image 30 and the object image 40. Thus, it is possible to improve interactiveness.

In the second embodiment, the example is explained in which, when it has been judged that the images collide with each other, the rendering of only the collided object image 40 is changed. However, the present invention is not limited to this example. Another arrangement is acceptable in which the rendering of only the conjunctive three-dimensional image 30 is changed, while the rendering of the collided object image 40 is not changed. Yet another arrangement is acceptable in which the rendering of both of the three-dimensional images is changed.

### Third Embodiment

Next, a stereoscopic image display apparatus according to a third embodiment of the present invention will be explained. Some of the constituent elements that are the same as those explained in the first and the second embodiments will be referred to by using the same reference characters, and the explanation thereof will be omitted.

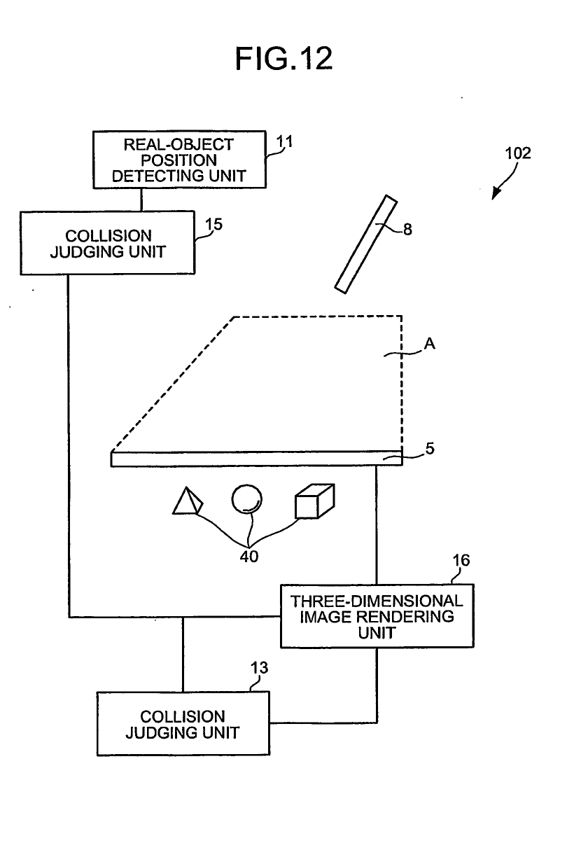

FIG. 12 is a drawing illustrating a functional configuration of the stereoscopic image display apparatus 102 according to the third embodiment. As shown in FIG. 12, as a result of the CPU 1 controlling the constituent elements according to the stereoscopic image displaying program, the stereoscopic image display apparatus 102 according to the third embodiment includes an area judging unit 15 and a three-dimensional image rendering unit 16, in addition to the real-object position detecting unit 11 and the collision judging unit 13 explained above.

The area judging unit 15 judges whether the handheld device 8 is present within a space area A that is specified near the stereoscopic image displaying unit 5, based on the position and the orientation direction of the handheld device 8 that have been derived by the real-object position detecting unit 11 and outputs a result of the judging process to the three-dimensional image rendering unit 16, as space position information.

More specifically, the area judging unit 15 compares coordinate data of the space area A that is stored in advance with the position and the orientation direction of the handheld device 8 that have been derived by the real-object position detecting unit 11. In a case where the handheld device 8 is positioned on the outside of the space area A, the area judging unit 15 outputs space position information indicating this situation to the three-dimensional image rendering unit 16. It is assumed that the coordinate data of the space area A is stored in the HDD 4 (i.e., the image storing unit) in advance. It is preferable to have an arrangement in which the area specified as the space area A is substantially the same as an area (i.e., the display space) in which a viewer is able to properly view the three-dimensional images displayed by the stereoscopic image displaying unit 5.

According to the third embodiment, the information indicating that the handheld device 8 is positioned on the outside of the space area A is output as the space position information. However, another arrangement is acceptable in which information indicating a relative positional relationship between the space area A and the conjunctive three-dimensional image 30 is output as the space position information. In this situation, an additional arrangement is acceptable in which, at a point in time when it has been judged that the conjunctive three-dimensional image 30 is positioned near the boundary of the space area A, the information indicating the relative positional relationship between the space area A and the conjunctive three-dimensional image 30 is output.

The three-dimensional image rendering unit 16 has functions that are similar to those of the three-dimensional image rendering unit 14 explained above. In addition, when having confirmed that the handheld device 8 is positioned on the outside of the space area A based on the space position information that has been input from the area judging unit 15, the three-dimensional image rendering unit 16 changes the level of transparency that is used when the conjunctive three-dimensional image 30 is rendered, from 100 percent to zero so that the conjunctive three-dimensional image 30 is not displayed.

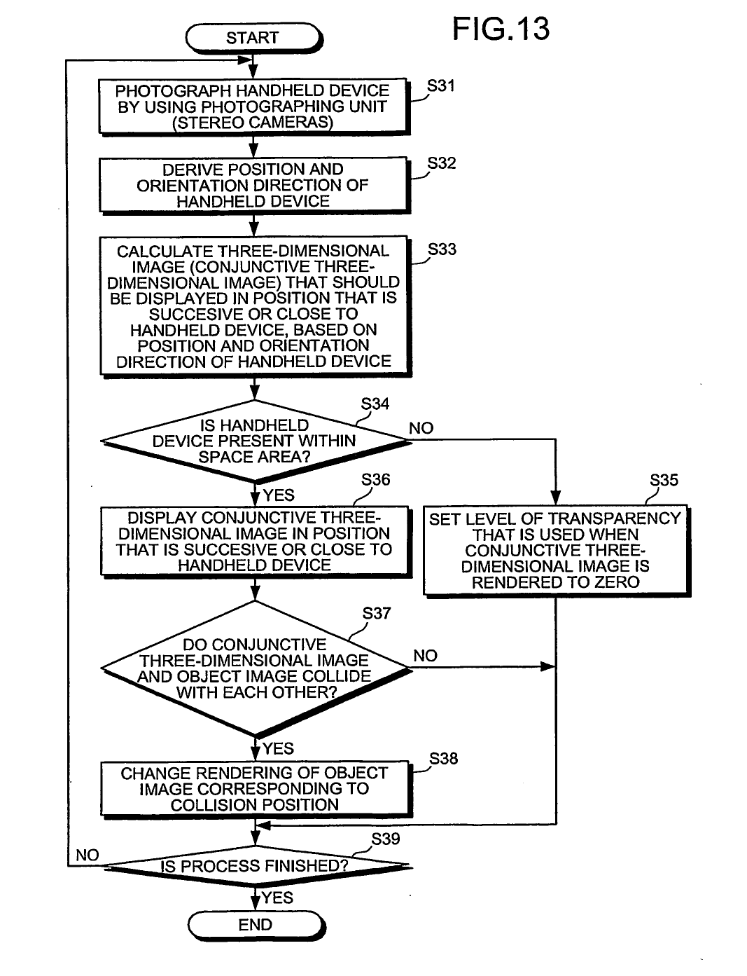

Next, an operation of the stereoscopic image display apparatus 102 according to the third embodiment will be explained, with reference to FIG. 13. FIG. 13 is a flowchart of a procedure in a stereoscopic image displaying process performed by the stereoscopic image display apparatus 102. It will be assumed herein that the object image 40 is displayed, in advance, in a predetermined position of the stereoscopic image displaying unit 5 by the three-dimensional image rendering unit 16.

First, the real-object position detecting unit 11 controls the stereo cameras 71 and 72 so that the stereo cameras 71 and 72 photograph light beams emitted from the point-like light emitting members 81 and 82 that are provided in the handheld device 8 (step S31). The real-object position detecting unit 11 then calculates the position and the orientation direction of the handheld device 8 with respect to the stereoscopic image displaying unit 5, based on the photograph information obtained by the stereo cameras 71 and 72 (step S32).

Next, the three-dimensional image rendering unit 16 performs a calculation process for rendering a three-dimensional image in a position that is successive or close to the handheld device 8, based on the position and the orientation direction of the handheld device 8 that have been derived at step S32 (step S33). At this time, the area judging unit 15 compares the position and the orientation direction of the handheld device 8 that have been calculated at step S32 with the coordinate data of the space area A and judges whether the handheld device 8 is present within the space area A (step S34).

At step S34, in a case where the area judging unit 15 has judged that the handheld device 8 is not present within the space area A (step S34: No), the three-dimensional image rendering unit 16 sets the level of transparency that is used when the conjunctive three-dimensional image 30 is rendered to zero, based on the judgment result (step S35), and the process proceeds to the procedure at step S39.

On the other hand, at step S34, in a case where the area judging unit 15 has judged that the handheld device 8 is present within the space area A (step S34: Yes), the three-dimensional image rendering unit 16 causes the three-dimensional image obtained in the calculation process at step S33 to be displayed as the conjunctive three-dimensional image 30 in a position that is successive or close to the handheld device 8 (step S36).

Subsequently, based on the display positions of the conjunctive three-dimensional image 30 and the object image 40 that are displayed by the three-dimensional image rendering unit 16, the collision judging unit 13 judges whether these two images collide with each other (step S37). In a case where the collision judging unit 13 has judged that the conjunctive three-dimensional image 30 and the object image 40 do not collide with each other (step S37: No), the process immediately proceeds to the procedure at step S39.

On the other hand, at step S37, in a case where the collision judging unit 13 has judged that the conjunctive three-dimensional image 30 and the object image 40 collide with each other (step S37: Yes), the three-dimensional image rendering unit 16 changes the rendering of the object image 40 corresponding to the collision position, based on the collision position information that has been obtained by the collision judging unit 13 (step S38), and the process proceeds to the procedure at step S39.

At the following step, namely step S39, the real-object position detecting unit 11 judges whether this process should be finished. In a case where, for example, the position information of the handheld device 8 is continually input from the stereo cameras 71 and 72 (step S39: No), the process returns to step S31.

On the other hand, at step S39, in a case where the position information of the handheld device 8 is no longer input because, for example, the handheld device 8 is positioned on the outside of the photographing areas of the stereo cameras 71 and 72 (step S39: Yes), the process is finished.

As explained above, according to the third embodiment, it is possible to exercise control so that the image is not displayed in the case where the handheld device 8 is in a position farther than the display limit for three-dimensional images. Thus, it is possible to exercise control so that the conjunctive three-dimensional image 30 will not be displayed any more than necessary.

In the third embodiment, the example is explained in which, when the handheld device 8 is positioned on the outside of the space area A, the control is exercised so that the conjunctive three-dimensional image 30 will not be displayed by changing the level of transparency that is used when the conjunctive three-dimensional image 30 is rendered together with the handheld device 8, from 100 to zero. However, the present invention is not limited to this example. For example, another arrangement is acceptable in which, in a case where the area judging unit 15 outputs space positional information indicating a relative positional relationship between the space area A and the conjunctive three-dimensional image 30, the three-dimensional image rendering unit 16 changes, in stages, the level of transparency that is used when the conjunctive three-dimensional image 30 is rendered, according to the relative positional relationship. In this situation, for example, by having an arrangement in which the level of transparency that is used when the conjunctive three-dimensional image 30 is rendered is lowered in stages, while the handheld device 8 gets closer to the boundary portion of the space area A, it is possible to express the disappearance of the conjunctive three-dimensional image 30 in a more natural manner.

### Fourth Embodiment

Next, a stereoscopic image display apparatus according to a fourth embodiment of the present invention will be explained. Some of the constituent elements that are the same as those explained in the first and the second embodiments will be referred to by using the same reference characters, and the explanation thereof will be omitted.

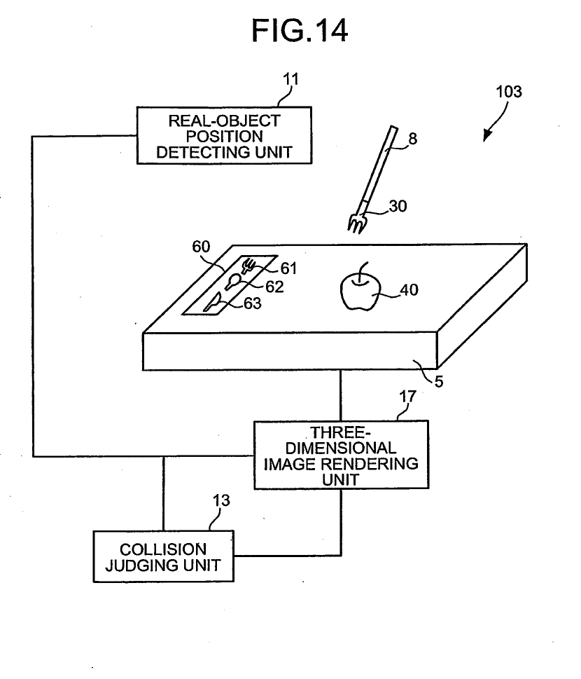

FIG. 14 is a drawing illustrating a functional configuration of the stereoscopic image display apparatus 103 according to the fourth embodiment. As shown in FIG. 14, as a result of the CPU 1 controlling the constituent elements according to the stereoscopic image displaying program, the stereoscopic image display apparatus 103 according to the fourth embodiment includes a three-dimensional image rendering unit 17, in addition to the real-object position detecting unit 11 and the collision judging unit 13 explained above.

The three-dimensional image rendering unit 17 has functions that are similar to those of the three-dimensional image rendering unit 14 explained above. In addition, as shown in FIG. 14, the three-dimensional image rendering unit 17 causes a plurality of three-dimensional images that are each displayable as the conjunctive three-dimensional image 30 to be displayed as image candidates 61 to 63 in a selection area 60. The number and the shapes of the image candidates are not limited to the example shown in the drawing. Also, although the three-dimensional images are displayed as the image candidates according to the fourth embodiment, the present invention is not limited to this example. For example, another arrangement is acceptable in which the image candidates are icon images that symbolically express the three-dimensional images or character information (e.g., “fork”, “spoon”, and “knife”) that expresses the shapes of the three-dimensional images.

Further, when having received collision position information indicating that the conjunctive three-dimensional image 30 has collided with (has come in contact with) one of the image candidates 61 to 63 displayed in the selection area 60 from the collision judging unit 13, the three-dimensional image rendering unit 17 causes the three-dimensional image corresponding to the image candidate in the collision position indicated in the collision position information to be displayed as the conjunctive three-dimensional image 30. It is assumed that the three-dimensional images that are displayed as the image candidates are stored in the HDD 4 (i.e., the image storing unit in advance.

Shown in FIG. 14 is an example in which, because the image candidate 61 has come in contact with the conjunctive three-dimensional image 30, the conjunctive three-dimensional image 30 in the shape of a fork corresponding to the image candidate 61 is displayed on one end of the handheld device 8. In this situation, in a case where the conjunctive three-dimensional image 30 has come in contact with another image candidate (i.e., the image candidate 62 or the image candidate 63), the display of the conjunctive three-dimensional image 30 is switched to a three-dimensional image of the image candidate that has come in contact.

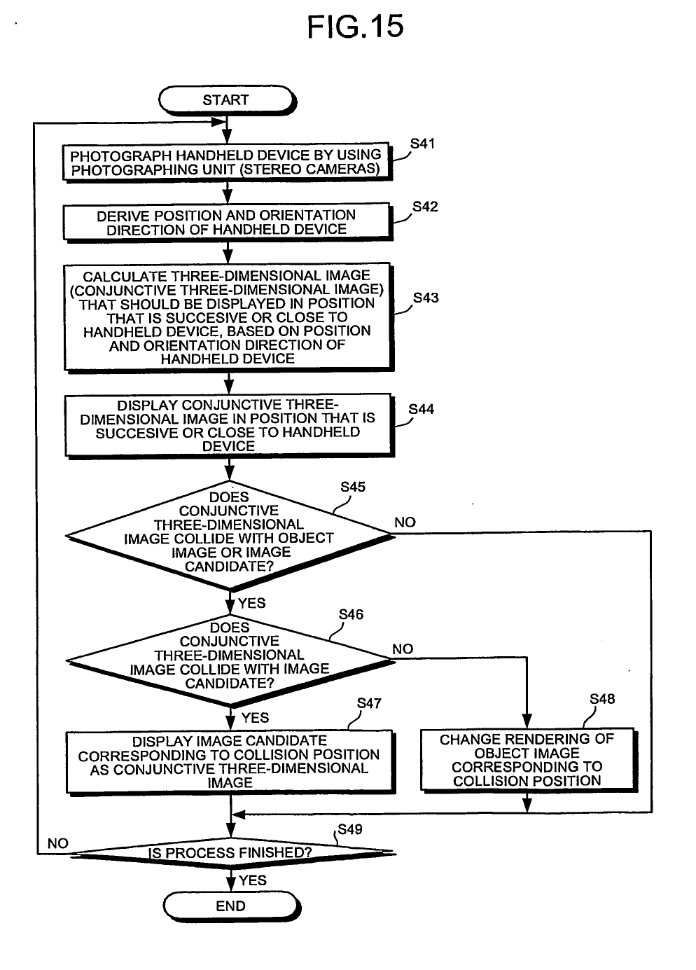

Next, an operation of the stereoscopic image display apparatus 103 according to the fourth embodiment will be explained, with reference to FIG. 15. FIG. 15 is a flowchart of a procedure in a stereoscopic image displaying process performed by the stereoscopic image display apparatus 103. It will be assumed herein that the object image 40 is displayed, in advance, in a predetermined position of the stereoscopic image displaying unit 5 by the three-dimensional image rendering unit 17.

First, the real-object position detecting unit 11 controls the stereo cameras 71 and 72 so that the stereo cameras 71 and 72 photograph light beams emitted from the point-like light emitting members 81 and 82 that are provided in the handheld device 8 (step S41). The real-object position detecting unit 11 then derives the position and the orientation direction of the handheld device 8 with respect to the stereoscopic image displaying unit 5, based on the photograph information obtained by the stereo cameras 71 and 72 (step S42).

Next, the three-dimensional image rendering unit 17 performs a calculation process for rendering a three-dimensional image in a position that is successive or close to the handheld device 8, based on the position and the orientation direction of the handheld device 8 that have been derived at step S42 (step S43) and causes the three-dimensional image to be displayed as the conjunctive three-dimensional image 30 in a position that is successive or close to the handheld device 8 (step S44).

Subsequently, the collision judging unit 13 judges whether the conjunctive three-dimensional image 30 displayed by the three-dimensional image rendering unit 17 collides with the object image 40 or any of the image candidates 61 to 63 (step S45). In a case where the collision judging unit 13 has judged that the conjunctive three-dimensional image 30 collides with no image (step S45: No), the process immediately proceeds to the procedure at step S49.

On the other hand, at step S45, in a case where the collision judging unit 13 has judged that the conjunctive three-dimensional image 30 collides with the object image 40 or one or more of the image candidates 61 to 63 (step S45: Yes), the three-dimensional image rendering unit 17 judges whether the conjunctive three-dimensional image 30 collides with one or more of the image candidates 61 to 63, based on the collision position information that has been obtained by the collision judging unit 13 (step S46).

In this situation, in a case where the collision judging unit 13 has judged that the conjunctive three-dimensional image 30 collides with one or more of the image candidates 61 to 63 (step S46: Yes), the three-dimensional image rendering unit 17 causes a three-dimensional image corresponding to the image candidate in the collision position to be displayed as the conjunctive three-dimensional image 30 (step S47), and the process proceeds to the procedure at step S49.

On the other hand, at step S46, in the case where the collision judging unit 13 has judged that the conjunctive three-dimensional image 30 collides with the object image 40 (step S46: No), the three-dimensional image rendering unit 17 changes the rendering of the object image 40 corresponding to the collision position, based on the collision position information obtained by the collision judging unit 13 (step S48), and the process proceeds to the procedure at step S49.

At the following step, namely step S49, the real-object position detecting unit 11 judges whether this process should be finished. In a case where, for example, the position information of the handheld device 8 is continually input from the stereo cameras 71 and 72 (step S49: No), the process returns to step S41.

On the other hand, at step S49, in a case where the position information of the handheld device 8 is no longer input because, for example, the handheld device 8 is positioned on the outside of the photographing areas of the stereo cameras 71 and 72 (step S49: Yes), the process is finished.

As explained above, according to the fourth embodiment, it is possible to easily change the image of the conjunctive three-dimensional image 30. Thus, it is possible to improve interactiveness.

### Fifth Embodiment

Next, a stereoscopic image display apparatus according to a fifth embodiment of the present invention will be explained. Some of the constituent elements that are the same as those explained in the first and the second embodiments will be referred to by using the same reference characters, and the explanation thereof will be omitted.

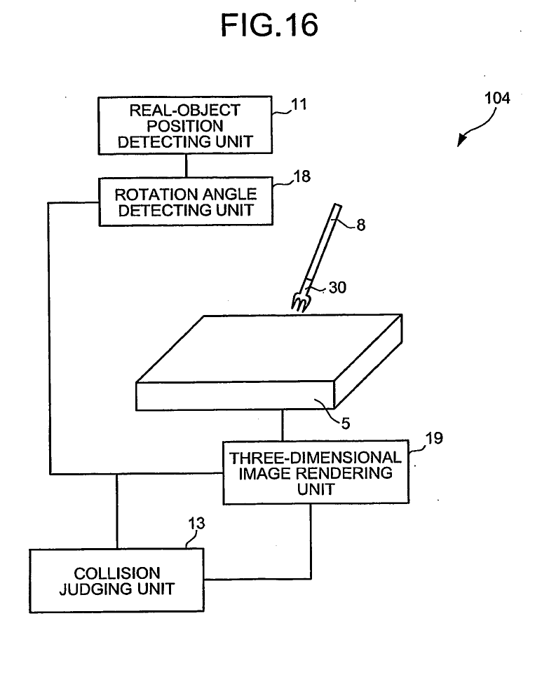

FIG. 16 is a drawing illustrating a functional configuration of the stereoscopic image display apparatus 104 according to the fifth embodiment. As shown in FIG. 16, as a result of the CPU 1 controlling the constituent elements according to the stereoscopic image displaying program, the stereoscopic image display apparatus 104 according to the fifth embodiment includes a rotation angle detecting unit 18 and a three-dimensional image rendering unit 19, in addition to the real-object position detecting unit 11 and the collision judging unit 13 explained above.

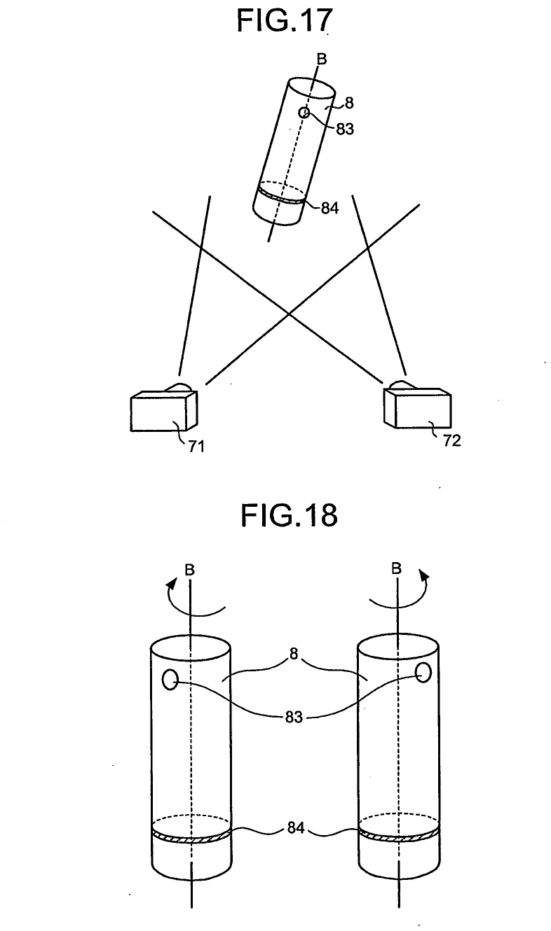

The rotation angle detecting unit 18 detects a rotation angle of the handheld device 8 on a predetermined axis. The method for detecting the rotation angle may be selected out of various types of methods. According to the fifth embodiment, the rotation angle of the handheld device 8 on the predetermined axis is detected by using a method described below. In the following sections, the method for detecting the rotation angle of the handheld device 8 will be explained, with reference to FIGS. 17 to 22.

FIG. 17 is a drawing for explaining the method for detecting the rotation angle of the handheld device 8 on an axis B. In this situation, a point-like light emitting member 83 is provided on one end, in terms of the direction in which the axis B extends, of the handheld device 8, whereas a linear light emitting member 84 is provided near the other end of the handheld device 8. The light beams emitted from the point-like light emitting member 83 and the linear light emitting member 84 are photographed by using the stereo cameras 71 and 72 and output as photograph information to the real-object position detecting unit 11 and the rotation angle detecting unit 18. In FIG. 18, shown on the right-hand side is how the emitted light beam is viewed when the handheld device 8 rotates to the left on the axis B, whereas shown on the left-hand side is how the emitted light beam is viewed when the handheld device 8 rotates to the right on the axis B.

Like the point-like light emitting members 81 and 82 explained above, the point-like light emitting member 83 may be configured with a point light source of a light emitting diode or the like. The linear light emitting member 84 is provided so as to extend in a circle around the axis B of the handheld device 8. The linear light emitting member 84 may be configured with, for example, a translucent disc trough which light can be guided and a light emitting diode that is placed at the center thereof. With this arrangement, the light beam emitted from the light emitting diode travels within the translucent disc, so as to be irradiated through the outer circumference of the disc to the outside of the disc, and thus the linear light emitting member 84 is formed. It is acceptable to arbitrarily set the direction in which the axis of the handheld device 8 extends, which is used as a reference for detecting the rotation angle. However, it is preferable to set the direction according to the position in which the handheld device 8 is held by the user.

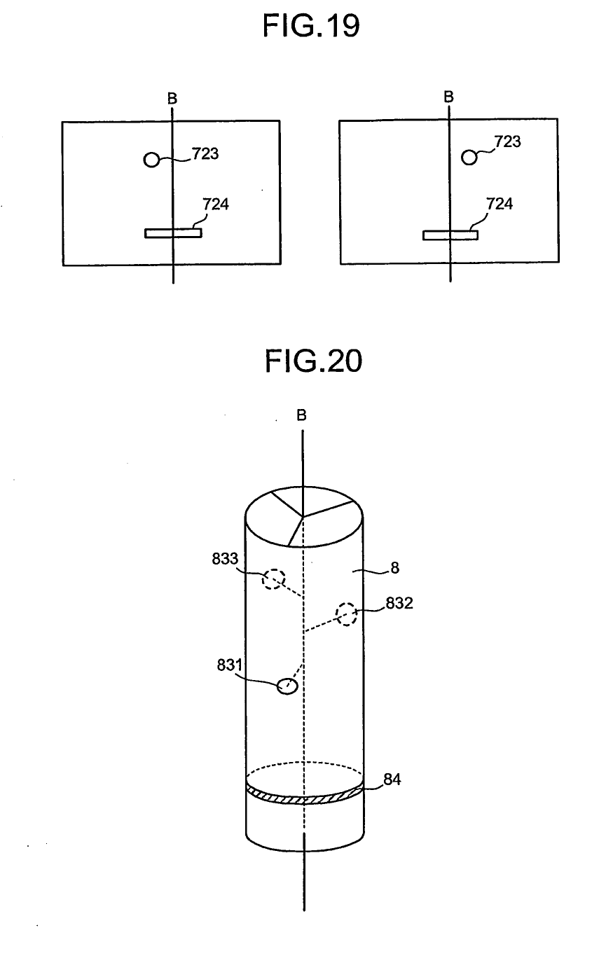

Shown in FIG. 19 are photographed pictures obtained by photographing the handheld device 8 shown in FIG. 18 by using the stereo cameras 71 and 72. In FIG. 19, shown on the left-hand side is a photographed picture of the light beam emitted from the handheld device 8 shown on the left-hand side of FIG. 18. Shown on the right-hand side of FIG. 19 is a photographed picture of the light beam emitted from the handheld device 8 shown on the right-hand side of FIG. 18. In FIG. 19, a photographed picture 723 corresponds to the light beam emitted from the point-like light emitting member 83, whereas a photographed picture 724 corresponds to the light beam emitted from the linear light emitting member 84.

As shown in FIG. 19, while the handheld device 8 rotates on the axis B, the positional relationship between the photographed picture 723 of the point-like light emitting member 83 and the photographed picture 724 of the linear light emitting member 84 changes. In other words, based on the positional relationship between the photographed picture 723 of the point-like light emitting member 83 and the photographed picture 724 of the linear light emitting member 84, it is possible to calculate how much the handheld device 8 has rotated on the axis B. Accordingly, it is possible to detect the rotation angle of the handheld device 8 in a simple and accurate manner.

The rotation angle detecting unit 18 derives the rotation angle of the handheld device 8 on the predetermined axis by using the principle explained above, based on the photographed pictures of the emitted light beams included in the photographed images that have been input from the stereo cameras 71 and 72. The rotation angle detecting unit 18 then outputs the derived rotation angle as angle information to the three-dimensional image rendering unit 19.

In the same manner as described above, the real-object position detecting unit 11 derives the position and the orientation direction of the handheld device 8, based on the photographed pictures of the emitted light beams included in the photographed images that have been input from the stereo cameras 71 and 72.

With reference to FIGS. 17 to 19, the example has been explained in which the one point-like light emitting member 83 is provided in the handheld device 8. However, the number of point-like light emitting members 83 is not limited to this example. For example, as shown in FIG. 20, another arrangement is acceptable in which a plurality of point-like light emitting members 83 (831, 832, and 833) are provided in the handheld device 8. Shown in FIG. 20 is an example in which the three point-like light emitting members 831 to 833 are provided in the handheld device 8 so as to be apart from one another by 120 degrees.

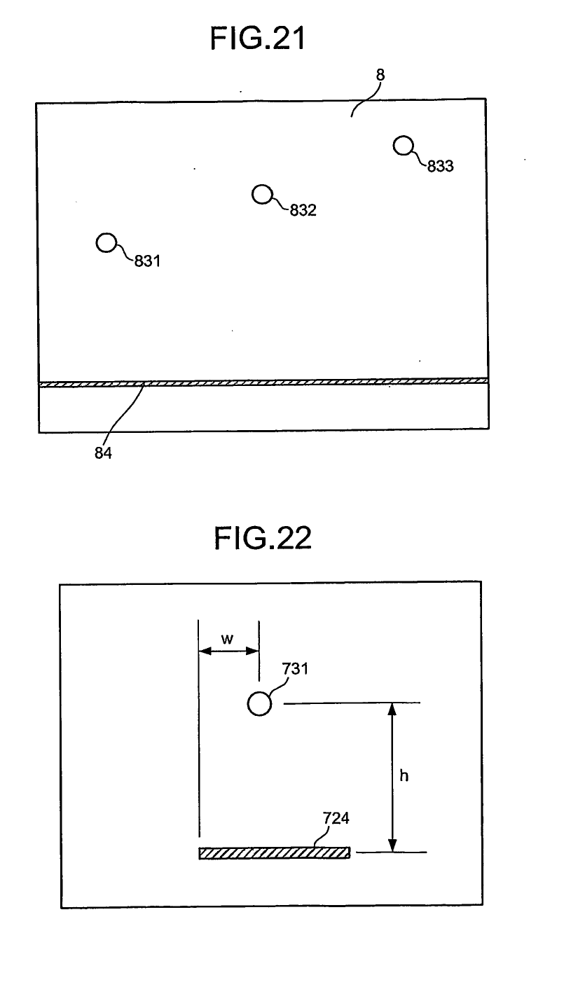

FIG. 21 is a drawing for explaining the handheld device 8 shown in FIG. 20. Shown in FIG. 21 is a development view of the handheld device 8. As shown in FIG. 21, the point-like light emitting members 831 to 833 are provided in mutually different positions in terms of the axial direction of the handheld device 8 so that it is possible to identify each of the point-like light emitting members. By positioning the point-like light emitting members 831 to 833 in this manner, it is always possible to photograph one of the point-like light emitting members 831 to 833 by using the stereo cameras 71 and 72, regardless of from which point around the axis, the handheld device 8 is viewed.

FIG. 22 is a drawing for explaining a principle of detecting the rotation angle of the handheld device 8 configured as described above. Shown in FIG. 22 is a photographed image that has been photographed by using one of the stereo cameras 71 and 72. In this example, the reference character 731 denotes a photographed picture of a light beam emitted from one of the point-like light emitting members 831 to 833. The reference character 724 denotes a photographed picture of a light beam emitted from the linear light emitting member 84. In this situation, by deriving a height h from the photographed picture 731 of the point-like light emitting member to the photographed picture 724 of the linear light emitting member, it is possible to identify one of angle sections in which the rotation angle is included, in a case where the rotation angle is arranged so as to fall into one of three rotation-angle sections that each have 120 degrees. When one of the angle sections has roughly been identified in this manner, it is possible to calculate the accurate angle based on the left-right positional relationship w between the photographed picture 724 of the linear light emitting member and the photographed picture 731 of the point-like light emitting member, as explained above.

Returning to the description of FIG. 16, the three-dimensional image rendering unit 19 has functions that are similar to those of the three-dimensional image rendering unit 14 explained above. In addition, the three-dimensional image rendering unit 19 causes the conjunctive three-dimensional image 30 corresponding to the rotation angle of the handheld device 8 on the axis that has been input from the rotation angle detecting unit 18 to be displayed in a position that is successive or close to the handheld device 8. More specifically, the three-dimensional image rendering unit 19 sets an axial direction that is the same as that of the handheld device 8 to the conjunctive three-dimensional image 30 and causes the conjunctive three-dimensional image 30 to be displayed in such a manner so as to be rotated on the axis by the angle corresponding to the rotation angle.

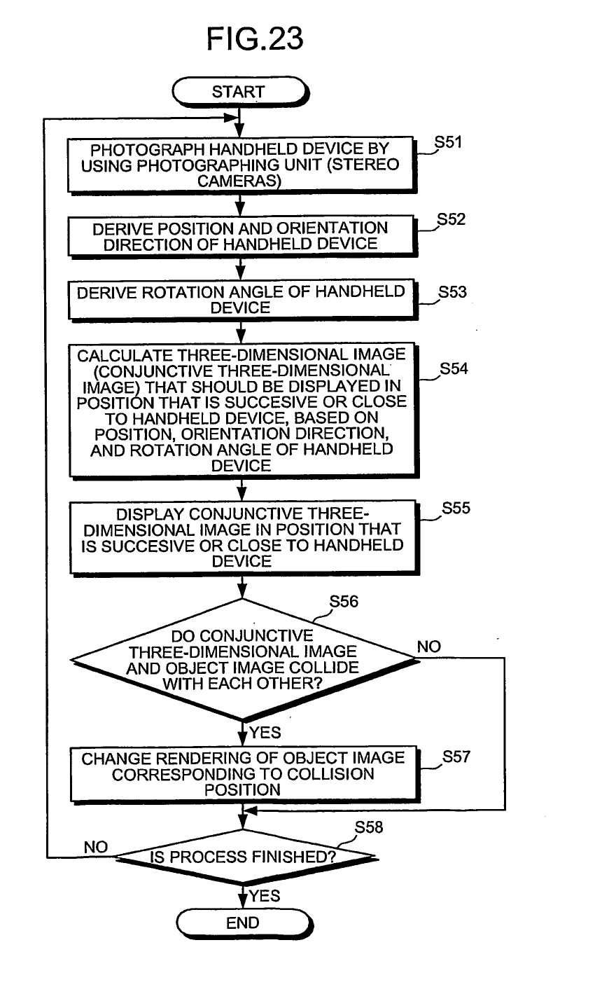

Next, an operation of the stereoscopic image display apparatus 104 according to the fifth embodiment will be explained, with reference to FIG. 23. FIG. 23 is a flowchart of a procedure in a stereoscopic image displaying process performed by the stereoscopic image display apparatus 104. It will be assumed herein that the object image 40 is displayed, in advance, in a predetermined position of the stereoscopic image displaying unit 5 by the three-dimensional image rendering unit 19.

First, the real-object position detecting unit 11 controls the stereo cameras 71 and 72 so that the stereo cameras 71 and 72 photograph light beams emitted from the point-like light emitting member 83 and the linear light emitting member 84 that are provided in the handheld device 8 (step S51). The real-object position detecting unit 11 then derives the position and the orientation direction of the handheld device 8 with respect to the stereoscopic image displaying unit 5, based on the photograph information obtained by the stereo cameras 71 and 72 (step S52).

Next, the rotation angle detecting unit 18 derives the rotation angle of the handheld device 8 on a predetermined axis, based on the photograph information obtained by the stereo cameras 71 and 72 (step S53). The three-dimensional image rendering unit 19 then performs a calculation process for rendering a three-dimensional image in a position that is successive or close to the handheld device 8, based on the position and the orientation direction of the handheld device 8 that have been derived at step S52 and the rotation angle of the handheld device 8 that has been derived at step S53 (step S54) and causes the three-dimensional image to be displayed as the conjunctive three-dimensional image 30 in the position that is successive or close to the handheld device 8 (step S55).

Subsequently, based on the display positions of the conjunctive three-dimensional image 30 and the object image 40 that are displayed by the three-dimensional image rendering unit 19, the collision judging unit 13 judges whether the conjunctive three-dimensional image 30 and the object image 40 collide with each other (step S56). In a case where the collision judging unit 13 has judged that the conjunctive three-dimensional image 30 and the object image 40 do not collide with each other (step S56: No), the process immediately proceeds to the procedure at step S58.

On the other hand, at step S56, in a case where the collision judging unit 13 has judged that the conjunctive three-dimensional image 30 and the object image 40 collide with each other (step S56: Yes), the three-dimensional image rendering unit 19 changes the rendering of the object image 40 corresponding to the collision position, based on the collision position information that has been obtained by the collision judging unit 13 (step S57), and the process proceeds to the procedure at step S58.

At the following step, namely step S58, the real-object position detecting unit 11 judges whether this process should be finished. In a case where, for example, the photograph information that is input from the stereo cameras 71 and 72 includes photographed pictures of the emitted light beams (step S58: No), the process returns to step S51.

On the other hand, at step S58, in a case where the photograph information that is input from the stereo cameras 71 and 72 includes no photographed pictures of the emitted light beams because, for example, the handheld device 8 is positioned on the outside of the photographing areas of the stereo cameras 71 and 72 (step S58: Yes), the process is finished.

As explained above, according to the fifth embodiment, the display of the conjunctive three-dimensional image 30 is changed according to the rotation angle of the handheld device 8. Thus, it is possible to display the conjunctive three-dimensional image 30 in a more realistic manner. Consequently, it is possible to further improve the interactiveness.

The first to the fifth embodiments of the present invention have been explained above. However, the present invention is not limited to these exemplary embodiments. It is possible to apply various modifications, replacements, and additions to these embodiments without departing from the scope of the present invention. For example, it is possible to make the speed of the calculation processes higher by using a Graphics Processing Unit (GPU) together with the CPU.

The program executed by the stereoscopic image display apparatus 100 according to the embodiment is provided as being incorporated in advance in the ROM 2 or the HDD 4. However, the present invention is not limited to this arrangement. Another arrangement is acceptable in which the program is provided as being recorded on a computer readable recording medium such as a Compact Disk Read-Only Memory (CD-ROM), a flexible Disk (FD), a Compact Disk Recordable (CD-R), or Digital Versatile Disk (DVD), in a file that is in an installable format or in an executable format. Yet another arrangement is acceptable in which the program is stored in a computer that is connected to a network such as the Internet and is provided as being downloaded via the network. It is also acceptable to provide or distribute the program via a network such as the Internet.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A stereoscopic image display apparatus that displays a three-dimensional image by using an integral imaging method or a light beam reproduction method, the stereoscopic image display apparatus comprising:
a position detecting unit that detects a position and an orientation direction of a handheld device positioned inside or near a display space provided over a three-dimensional display screen and held by a user;
a calculation processing unit that performs a calculation process for displaying the three-dimensional image in a position that is successive or close to the handheld device, based on the position and the orientation direction of the handheld device; and
a display controlling unit that causes the three-dimensional image to be displayed as a conjunctive three-dimensional image in the position that is successive or close to the handheld device, based on a result of the calculation process performed by the calculation processing unit.

2. The stereoscopic image display apparatus according to claim 1, wherein the display controlling unit causes the conjunctive three-dimensional image to be displayed as an optical real image on a real-image side of the three-dimensional display screen and causes the conjunctive three-dimensional image to be displayed as an optical virtual image on a virtual-image side of the three-dimensional display screen.

3. The stereoscopic image display apparatus according to claim 2, further comprising:
a collision judging unit that judges whether the conjunctive three-dimensional image collides with another three-dimensional image, based on the position in which the conjunctive three-dimensional image is displayed and a position in which said another three-dimensional image is displayed, wherein
the display controlling unit changes rendering of one or both of the conjunctive three-dimensional image and the another three-dimensional image, according to a result of the judging by the collision judging unit.

4. The stereoscopic image display apparatus according to claim 3, further comprising:
an area judging unit that judges, based on coordinate data defining a predetermined space area positioned over the three-dimensional display screen and the position and the orientation direction of the handheld device, whether the handheld device is present within the space area, wherein
the display controlling unit changes rendering of the conjunctive three-dimensional image according to a result of the judging by the area judging unit.

5. The stereoscopic image display apparatus according to claim 3, further comprising:
a photographing unit that photographs two or more point-like light emitting members provided in the handheld device and generates a photographed image, wherein
the position detecting unit derives the position and the orientation direction of the handheld device, based on a positional relationship between photographed pictures of the point-like light emitting members included in the photographed image.

6. The stereoscopic image display apparatus according to claim 3, further comprising:
a selection candidate displaying unit that causes a plurality of three-dimensional images to be displayed on the three-dimensional display screen, the plurality of three-dimensional images serving as candidate images that are displayable as the conjunctive three-dimensional image; and
a selection receiving unit that receives a designation of one of the three-dimensional images serving as the candidate images, wherein
the display controlling unit causes the one of the three-dimensional images specified in the received designation to be displayed as the conjunctive three-dimensional image.

7. The stereoscopic image display apparatus according to claim 3, further comprising:
a rotation detecting unit that detects a rotation angle of the handheld device, wherein
the display controlling unit changes rendering of the conjunctive three-dimensional image according to the rotation angle of the handheld device.

8. The stereoscopic image display apparatus according to claim 7, further comprising:
a photographing unit that photographs at least one point-like light emitting member provided in the handheld device and a linear light emitting member provided on a circumference of the handheld device, and generates a photographed image, wherein
the rotation detecting unit derives the rotation angle of the handheld device, based on a positional relationship between photographed pictures of the point-like light emitting member and the linear light emitting member included in the photographed image.

9. A stereoscopic image display method used by a stereoscopic image display apparatus that displays a three-dimensional image by using an integral imaging method or a light beam reproduction method, the stereoscopic image display method comprising:
detecting a position and an orientation direction of a handheld device positioned inside or near a display space provided over a three-dimensional display screen and held by a user;
performing a calculation process for displaying the three-dimensional image in a position that is successive or close to the handheld device, based on the position and the orientation direction of the handheld device; and
causing the three-dimensional image to be displayed as a conjunctive three-dimensional image in the position that is successive or close to the handheld device, based on a result of the calculation process performed by the step of calculation processing.

10. A computer program product having a computer readable medium including programmed instructions for displaying a three-dimensional image by using an integral imaging method or a light beam reproduction method, wherein the instructions, when executed by a computer, cause the computer to perform:
detecting a position and an orientation direction of a handheld device positioned inside or near a display space provided over a three-dimensional display screen and held by a user;
performing a calculation process for displaying the three-dimensional image in a position that is successive or close to the handheld device, based on the position and the orientation direction of the handheld device; and
causing the three-dimensional image to be displayed as a conjunctive three-dimensional image in the position that is successive or close to the handheld device, based on a result of the calculation process performed by the step of calculation processing.
